(19) United States
(12) Patent Application Publication
(10) Pub. No.: US 2026/0303815 A1
(43) Pub. Date: Oct. 1, 2026

(54) METHOD AND APPARATUS FOR VIDEO CODING FOR EFFICIENT TRANSMISSION OF GEOMETRIC PARTITIONING INFORMATION

(71) Applicants: Hyundai Motor Company, Seoul (KR); Kia Corporation, Seoul (KR); KWANGWOON UNIVERSITY INDUSTRY-ACADEMIC COLLABORATION FOUNDATION, Seoul (KR)

(72) Inventors: Sea Nae PARK, Seoul (KR); Min Hun LEE, Uijeongbu-si, Gyeonggi-do (KR); Dong Gyu SIM, Seoul (KR); Jin HEO, Yongin-si, Gyeonggi-do (KR); Jung Ah CHOI, Seoul (KR); Seung Wook PARK, Yongin-si, Gyeonggi-do (KR)

(73) Assignees: Hyundai Motor Company, Seoul (KR); Kia Corporation, Seoul (KR); KWANGWOON UNIVERSITY INDUSTRY-ACADEMIC COLLABORATION FOUNDATION, Seoul (KR)

(21) Appl. No.: 19/479,498

(22) PCT Filed: Mar. 11, 2024
(86) PCT No.: PCT/KR2024/003079

§ 371 Date: Oct. 28, 2025

(30) Foreign Application Priority Data
May 16, 2023 (KR) 10-2023-0062811
Mar. 8, 2024 (KR) 10-2024-0033416

(51) Int. Cl. H04N 19/136; H04N 19/105; H04N 19/176; H04N 19/70

(52) U.S. Cl. CPC H04N 19/136; H04N 19/105; H04N 19/176; H04N 19/70

(57) ABSTRACT

A method and an apparatus are disclosed for video coding for transmitting geometric partitioning information efficiently. In the disclosed embodiments, the video decoding apparatus obtains high level information related to applying a geometric partitioning mode, and determines whether, at a block boundary between the neighboring block and the current block, there is a contact point due to a partitioning boundary of neighboring blocks. When there is at least one or more of the contact point, the video decoding apparatus generates a partitioned boundary predictor of the current block by using partitioning boundary information of the neighboring block. The video decoding apparatus obtains difference information of the geometric partitioning mode, and generates partitioning boundary information of the current block by summing the partitioned boundary predictor and the difference information. The video decoding apparatus generates partitioned blocks of the current block based on the high level information and the partitioning boundary information.

### TECHNICAL FIELD

The present disclosure relates to a video coding method and an apparatus for transmitting geometric partitioning information efficiently.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Video coding methods and devices utilize inter prediction technology for predicting the current block through generating a prediction block by using pixels in a temporally adjacent picture. To improve the performance of inter prediction, techniques are in an attempt to perform inter prediction on a single block by the unit of one or more subblocks. With the above-mentioned block-level prediction techniques, prediction is limited to using square or rectangular block partitions, which suffers from difficulties in performing prediction for objects of random shapes within the video.

To overcome these limitations, there are attempted methods of using arbitrary block partitions in addition to square or rectangular block partitions. A representative arbitrary block partitioning involves dividing rectangular blocks by using straight lines with arbitrary angles. The VVC standardization process proposed a new technique that involves splitting each block by using arbitrary line segments and blending the split blocks to generate a single final inter predictor. This technique is named the geometric partitioning mode (GPM) and was ultimately included in the VVC standard. The above-described GPM is limited to be used in the merge mode of inter-prediction modes.

In the GPM technique, the encoder transmits information on the geometric partition to the decoder. Therefore, to increase video coding efficiency and enhance video quality, there is a need for a method of transmitting information on the geometric partition efficiently when performing prediction according to the geometric partitioning mode.

### DISCLOSURE

### Technical Problem

The present disclosure seeks to provide a video coding method and an apparatus that efficiently transmit information on geometric partitions and additional information in geometric partitioning mode-based prediction.

### Technical Solution

At least one aspect of the present disclosure provides a method of reconstructing a current block by a video decoding apparatus. The method includes obtaining high level information related to applying a geometric partitioning mode. The method also includes determining whether there is a neighboring block reconstructed according to the geometric partitioning mode. The method also includes determining whether, at a block boundary between the neighboring block and the current block, there is a contact point due to a partitioning boundary of neighboring blocks. When there is at least one or more of the contact point, the method further includes generating a partitioned boundary predictor of the current block by using partitioning boundary information of the neighboring block. The method further includes obtaining difference information of the geometric partitioning mode. The method further includes generating partitioning boundary information of the current block by summing the partitioned boundary predictor and the difference information. The method further includes generating partitioned blocks of the current block based on the high level information and the partitioning boundary information.

Another aspect of the present disclosure provides a method of encoding a current block by a video encoding apparatus. The method includes determining high level information related to applying a geometric partitioning mode. The method also includes generating partitioning boundary information of the current block based on the high level information. The method also includes generating partitioned blocks of the current block based on the partitioning boundary information. The method also includes determining whether there is a neighboring block reconstructed according to the geometric partitioning mode. The method also includes determining whether, at a block boundary between the neighboring block and the current block, there is a contact point due to a partitioning boundary of neighboring blocks. When there is at least one or more of the contact point, the method further includes generating a partitioned boundary predictor of the current block by using partitioning boundary information of the neighboring block. The method further includes generating difference information by subtracting the partitioned boundary predictor from the partitioning boundary information of the current block.

Yet another aspect of the present disclosure provides a computer-readable recording medium storing a bitstream generated by a video encoding method. The video encoding method includes determining high level information related to applying a geometric partitioning mode. The video encoding method also includes generating partitioning boundary information of a current block based on the high level information. The video encoding method also includes generating partitioned blocks of the current block based on the partitioning boundary information. The video encoding method also includes determining whether there is a neighboring block reconstructed according to the geometric partitioning mode. The video encoding method also includes determining whether, at a block boundary between the neighboring block and the current block, there is a contact point due to a partitioning boundary of neighboring blocks. When there is at least one or more of the contact point, the video encoding method further includes generating a partitioned boundary predictor of the current block by using partitioning boundary information of the neighboring block. The video encoding method further includes generating difference information by subtracting the partitioned boundary predictor from the partitioning boundary information of the current block.

### Advantageous Effects

As described above, the present disclosure provides a video coding method and an apparatus that efficiently transmit information on geometric partitioning and additional information in geometric partitioning mode-based prediction. Thus, the video coding method and the apparatus improve increase video coding efficiency, and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating block partitioning according to geometric partitioning.

FIGS. 7A and 7B are diagrams illustrating straight lines that split blocks into two parts.

FIG. 8 is a diagram conceptually illustrating inter prediction using geometric partitioning.

FIG. 9 is a diagram illustrating a geometric partitioning mode (GPM) merge list used for geometric motion prediction.

FIGS. 10A through 10D are diagrams illustrating the prediction of geometric partition information, according to some embodiments of the present disclosure.

FIGS. 11A through 11C are diagrams illustrating a composite partitioning mode according to some embodiments of the present disclosure.

FIG. 12 is a flowchart of a method of encoding a current block by a video encoding apparatus, according to at least one embodiment of the present disclosure.

FIG. 13 is a flowchart of a method of reconstructing a current block by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

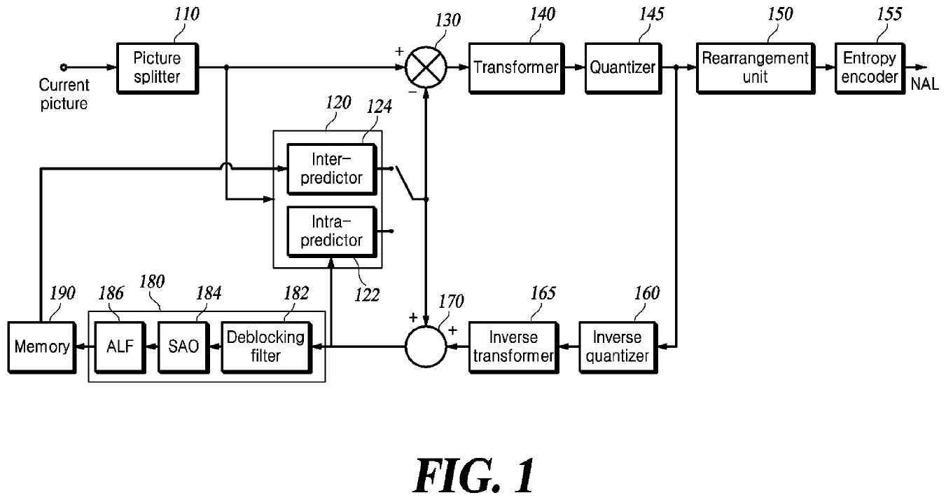

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

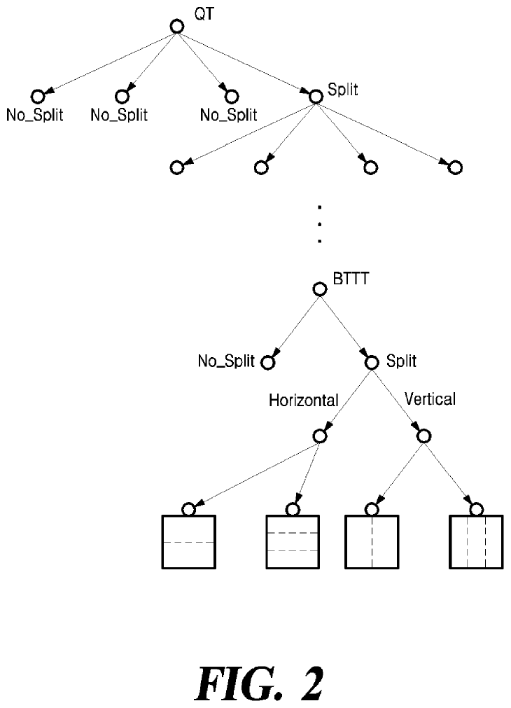

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

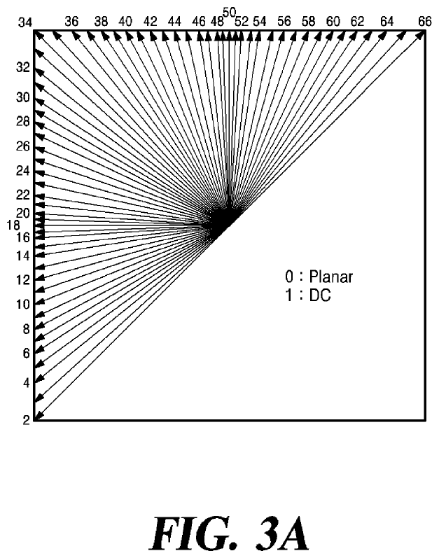

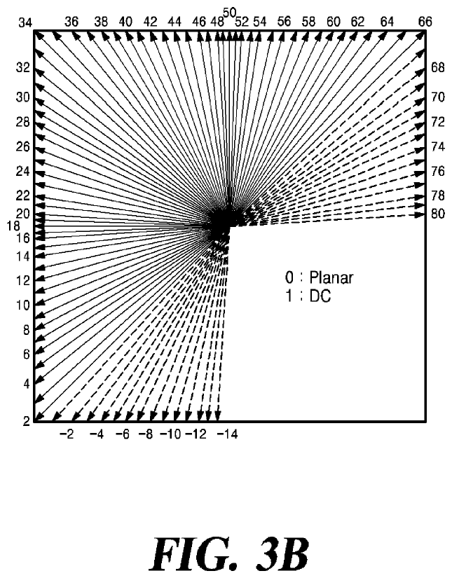

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (intra prediction modes #67 to #80, #-1 to #-14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

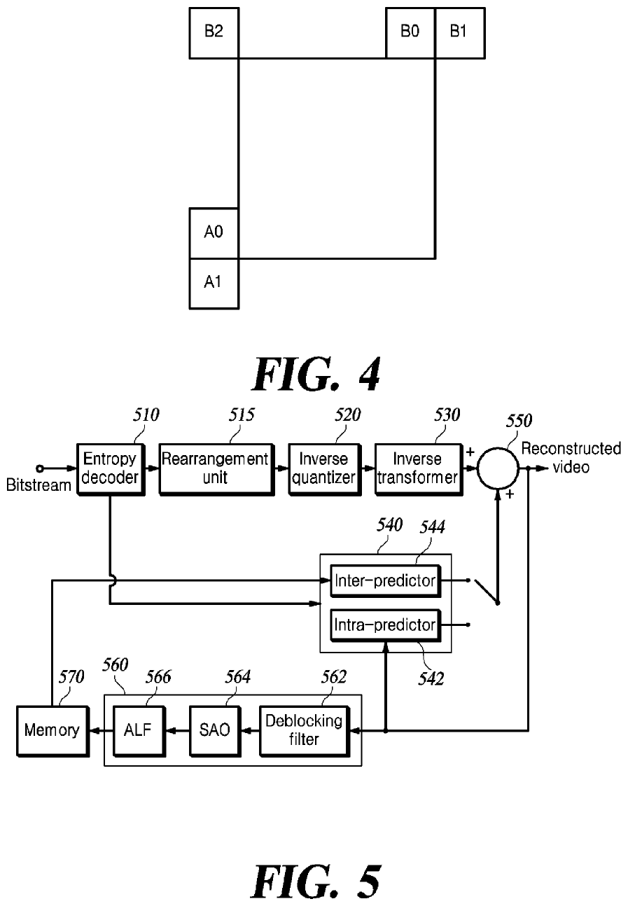

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510, and predicts the current block by using the motion vector and the reference picture.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus apparatuses that efficiently transmit information about geometric partitions and additional information in performing predictions based on geometric partitioning mode.

The following embodiments may be performed by the inter predictor 124 in the video encoding device. The following embodiments may also be performed by the inter predictor 544 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Merge/Skip Mode In Inter Prediction

The following describes a method of constructing a merge candidate list of motion information in the merge/skip mode of inter prediction. To support the merge/skip mode, the video encoding apparatus may construct the merge candidate list by selecting a preset number (e.g., 6) of merge candidates.

The video encoding apparatus searches for spatial merge candidates. The video encoding apparatus searches for spatial merge candidates from neighboring blocks, as shown in FIG. 4. Up to four spatial merge candidates may be selected.

The video encoding apparatus searches for temporal merge candidates. The video encoding apparatus may add as a temporal merge candidate a block co-located with the current block, which is within a reference picture other than the current picture where the target block is located. Here, the reference picture may be the same as or different from the reference picture used to predict the current block. One temporal merge candidate may be selected.

The video encoding apparatus searches for History-based Motion Vector Predictor (HMVP) candidates. The video encoding apparatus may store the motion vectors of the previous h CUs (where h is a natural number) in a table and may use the motion vectors as merge candidates. The size of the table is 6, and the table stores the motion vectors of the previous CUs in a first-in first-out (FIFO) manner. This indicates that up to 6 HMVP candidates may be stored in the table. The video encoding apparatus may set as merge candidates the most recent motion vectors among the HMVP candidates stored in the table.

The video encoding apparatus searches for Pairwise Average MVP (PAMVP) candidates. The video encoding apparatus may set as a merge candidate the average of the motion vectors of the first and second candidates in the merge candidate list.

If the merge candidate list cannot be filled even after performing all of the above search processes, i.e., if the preset number of merge candidates cannot be recruited, the video encoding apparatus adds zero motion vectors as merge candidates.

In terms of coding efficiency optimization, the video encoding apparatus may determine a merge index that indicates one candidate in the merge candidate list. The video encoding apparatus may use the merge index to derive a motion vector predictor (MVP) from the merge candidate list, and then may determine the MVP as the motion vector of the current block. Additionally, the video encoding apparatus may signal the merge index to the video decoding apparatus.

In skip mode, the video encoding apparatus uses the same motion vector transmission method as in merge mode, but does not transmit the residual block that equals to the difference between the current block and the prediction block.

The above-described method of constructing the merge candidate list may be performed equally by the video decoding apparatus. The video decoding apparatus may decode the merge index. The video decoding apparatus may use the merge index to derive the MVP from the merge candidate list, and then may determine the MVP as the motion vector of the current block.

The following embodiments are described with a focus on the video decoding apparatus, but they can be implemented in the same or similar manner in the video encoding apparatus.

### II. Geometric Partitioning Mode (GPM)

The following embodiments are described with a focus on the video decoding apparatus, but they can be implemented in the same or similar manner in the video encoding apparatus.

In versatile video coding (VVC), GPM uses prediction units of various shapes rather than rectangular shapes.

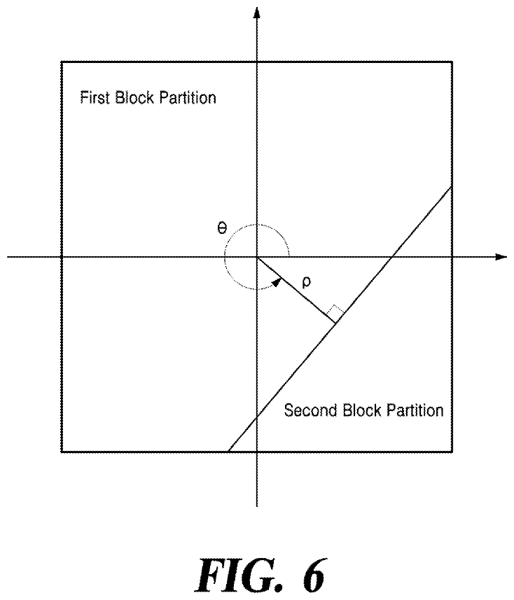

FIG. 6 is a diagram illustrating block partitioning according to geometric partitioning.

The video decoding apparatus divides the current block into two parts by a straight line perpendicular to a line segment with a certain angle θ and a certain distance p from the center of the block. Hereinafter, the two divided blocks are referred to as the first block partition and the second block partition. Block partition is used interchangeably with partitioned block. The straight line that divides the current block is called the partitioning boundary.

Here, the center of the block represents a single virtual position with the current block before partitioning where the ½ position of the height of the block and the ½ position of the width of the block intersect. The angle θ represents the angle rotated counterclockwise from the virtual horizontal axis passing through the center of the block to the line segment perpendicular to the partitioning boundary. The distance p represents the distance between the center of the block and the partitioning boundary.

As described above, the straight line that divides the block into two parts, i.e., the partitioning boundary, divides the current block into two different block partitions. The video decoding apparatus uses the above-described geometric partition to divide the current block into two blocks, the first block partition and the second block partition, which perform separate predictions based on the partitioning boundary.

As an example, in the conventional GPM, information on the partitioning boundary as illustrated in FIG. 6 is signaled from the video encoding apparatus to the video decoding apparatus. The video decoding apparatus may use the parsed partitioning boundary information to decode the geometric block partitions of the current block. Here, the partitioning boundary information may include the angle θ and distance ρ that are based on the center of the block. Additionally, the video encoding apparatus may further signal information indicating whether GPM is to be applied, to the video decoding apparatus.

Hereinafter, the information on the partitioning boundary according to the geometric partitioning mode is used interchangeably with geometric partitioning mode information, geometric partition information, or partitioning information.

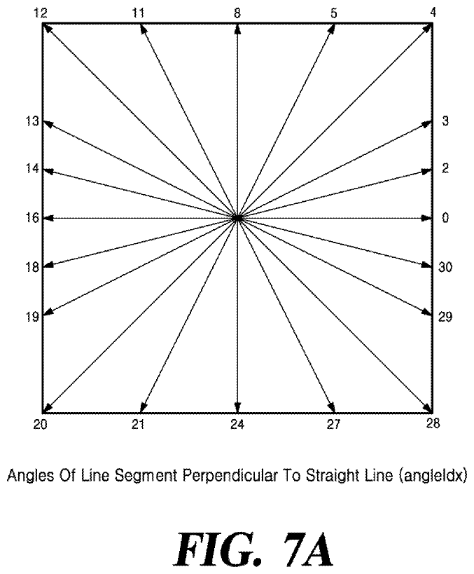

FIGS. 7A and 7B are diagrams illustrating straight lines that split blocks into two parts.

As another example, a lookup table may be configured to include combinations of angles and distances that divide the current block into a first block partition and a second block partition, as shown in FIG. 7A, FIG. 7B, and Table 1. Then, an index indicating the combination of an angle and a distance in the lookup table may be signaled from the video encoding apparatus to the video decoding apparatus. The combinations of angles and distances corresponding to the respective indices may be defined based on a fixed lookup table in accordance with an agreement between the video encoding apparatus and the video decoding apparatus. As a modification, the lookup table may be adaptively reconfigured in accordance with a pre-agreed rule.

As described above, the geometric partition shape is based on a partitioning boundary which is a straight line representing the two partitions of a block. Such information of straight line may include an index distanceIdx representing the distance ρ from the center of the block to the partitioning boundary, and an index angleIdx representing the angle θ of a line segment perpendicular to the partitioning boundary. The indices indicating the angles of the line segment perpendicular to the partitioning boundary may be set as shown in FIG. 7A. Furthermore, the 64 geometric partition shapes based on these angles and distances may be set as shown in FIG. 7B.

The 64 geometric partition shapes may be signaled by using the syntax merge_gpm_partition_idx which is an index indicating the geometric partition shape, as shown in Table 1. Namely, the forms of dividing the current block into the first block partition and the second block partition according to various angles and distances can be efficiently signaled by using a single index.

TABLE 1

| merge_gpm_partition_idx | 0 | 1 | 2 | 3 | 4 | 5 | 6 | 7 |
|---|---|---|---|---|---|---|---|---|
| angleIdx | 0 | 0 | 2 | 2 | 2 | 2 | 3 | 3 |
| distanceIdx | 1 | 3 | 0 | 1 | 2 | 3 | 0 | 1 |
| merge_gpm_partition_idx | 8 | 9 | 10 | 11 | 12 | 13 | 14 | 15 |
| angleIdx | 3 | 3 | 4 | 4 | 4 | 4 | 5 | 5 |
| distanceIdx | 2 | 3 | 0 | 1 | 2 | 3 | 0 | 1 |
| merge_gpm_partition_idx | 16 | 17 | 18 | 19 | 20 | 21 | 22 | 23 |
| angleIdx | 5 | 5 | 8 | 8 | 11 | 11 | 11 | 11 |
| distanceIdx | 2 | 3 | 1 | 3 | 0 | 1 | 2 | 3 |
| merge_gpm_partition_idx | 24 | 25 | 26 | 27 | 28 | 29 | 30 | 31 |
| angleIdx | 12 | 12 | 12 | 12 | 13 | 13 | 13 | 13 |
| distanceIdx | 0 | 1 | 2 | 3 | 0 | 1 | 2 | 3 |
| merge_gpm_partition_idx | 32 | 33 | 34 | 35 | 36 | 37 | 38 | 39 |
| angleIdx | 14 | 14 | 14 | 14 | 16 | 16 | 18 | 18 |
| distanceIdx | 0 | 1 | 2 | 3 | 1 | 3 | 1 | 2 |
| merge_gpm_partition_idx | 40 | 41 | 42 | 43 | 44 | 45 | 46 | 47 |
| angleIdx | 18 | 19 | 19 | 19 | 20 | 20 | 20 | 21 |
| distanceIdx | 3 | 1 | 2 | 3 | 1 | 2 | 3 | 1 |
| merge_gpm_partition_idx | 48 | 49 | 50 | 51 | 52 | 53 | 54 | 55 |
| angleIdx | 21 | 21 | 24 | 24 | 27 | 27 | 27 | 28 |
| distanceIdx | 2 | 3 | 1 | 3 | 1 | 2 | 3 | 1 |
| merge_gpm_partition_idx | 56 | 57 | 58 | 59 | 60 | 61 | 62 | 63 |
| angleIdx | 28 | 28 | 29 | 29 | 29 | 30 | 30 | 30 |
| distanceIdx | 2 | 3 | 1 | 2 | 3 | 1 | 2 | 3 |

The index distanceIdx derived from the example in FIG. 7B is a value excluding the size of the current block. Therefore, the actual distance between the pixels in the current block and the straight line may be calculated by using the size information of the current block, the index angleIdx representing the angle, and the index distanceIdx representing the distance. Here, the actual distance is a value expressed in pixel units.

Meanwhile, the actual distance may be used to calculate the weight of each pixel in the current block. For example, for a single pixel in the first block partition, as the actual distance between the pixel and the straight line increases, the weight of the predictor of the first block partition, as described above, increases, and the weight of the predictor of the second block partition decreases. For pixels located on the partitioning boundary, the two predictors may use weights with the same value. In this case, the sum of the weights of the two predictors for a single pixel is maintained at 1.

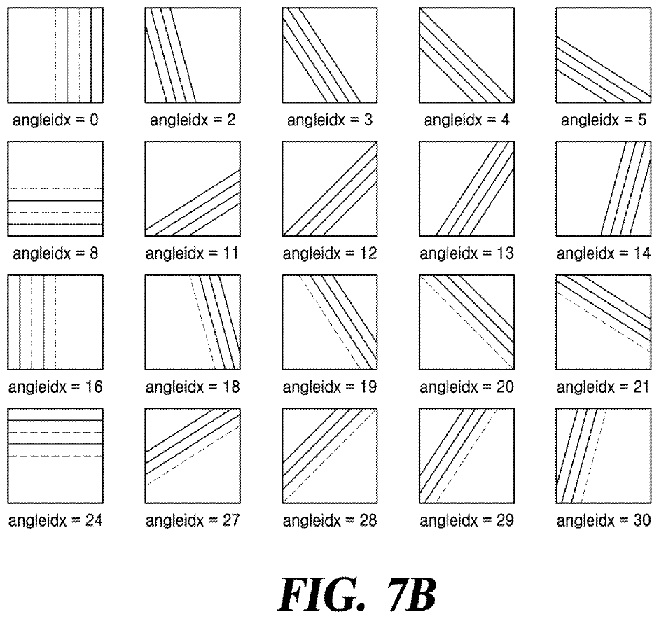

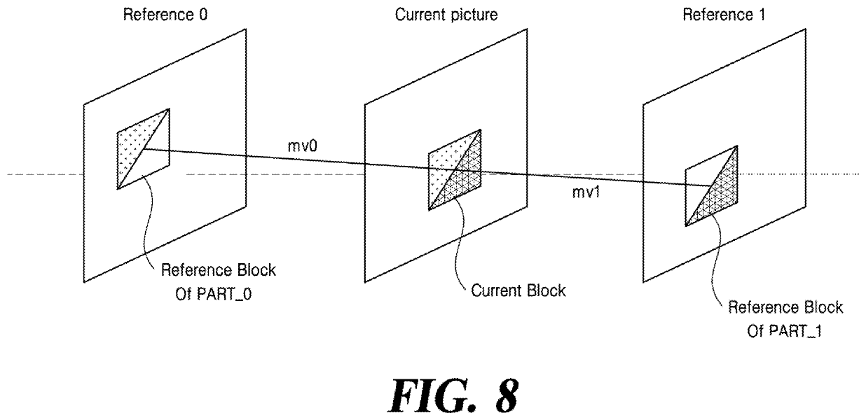

FIG. 8 is a diagram conceptually illustrating inter prediction using geometric partitioning.

As illustrated in FIG. 8, on two different block partitions of the current block existing within the current picture, the video decoding apparatus performs prediction by using each motion vector (mv0 or mv1). The video decoding apparatus applies a weighted summation-based blending process to the prediction block of the first block partition and the prediction block for the second block partition to generate the final prediction block of the current block. In the example of FIG. 8, PART_0 represents the first block partition, and PART_1 represents the second block partition. Furthermore, the reference block of PART_0 represents the prediction block of the first block partition, and the reference block of PART_1 represents the prediction block of the second block partition.

To perform inter prediction of the current block as shown in FIG. 8, the video decoding apparatus uses a motion vector of the first block partition to obtain a first prediction block, and uses a motion vector of the second block partition to obtain a second prediction block. At this time, the video decoding apparatus may obtain, in the process of obtaining the prediction block of each block partition, the same in a form multiplied by different weights according to the pixel position, as described above. In the process of generating the final prediction block from the prediction blocks multiplied by weights, the video decoding apparatus may use shift and clipping operations.

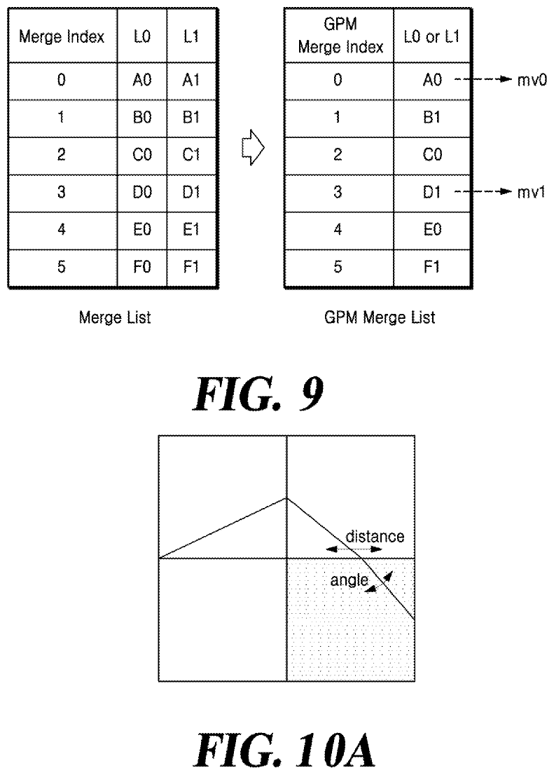

FIG. 9 is a diagram illustrating a geometric partitioning mode (GPM) merge list used for geometric motion prediction.

When performing the geometric motion prediction shown in FIG. 8, the video decoding apparatus may select, from the merge list, and then may use motion information for motion prediction, as illustrated in FIG. 9.

However, unlike conventional block-wise motion prediction techniques, for geometric motion prediction, the video decoding apparatus performs unidirectional prediction on a single block partition by limiting the prediction direction, as shown in FIG. 9. This is because, compared to block-wise motion prediction, in geometric motion prediction, when performing motion prediction by bi-prediction for each block partition, the memory bandwidth used for prediction can be twofold. Therefore, to efficiently address the above-described memory bandwidth increase issue, a technique that limits the directionality of prediction for each block partition may be applied.

In the case where the directionality of prediction is restricted for each block partition in geometric motion prediction, a GPM merge list for geometric motion prediction may be generated by using the existing merge list. To generate the GPM merge list, the video decoding apparatus first constructs the merge list as described above. Then, the video decoding apparatus may generate a GPM merge list for geometric motion prediction by the prediction directionality and the order within the list. At this point, the video decoding apparatus adds L0-direction motion information to the GPM merge list to generate merge candidates for geometric motion prediction of the first block partition. In addition, the video decoding apparatus may add L1-direction motion information to the GPM merge list to generate merge candidates for geometric motion prediction of the second block partition. In other words, the video decoding apparatus may derive unidirectional motion information of one direction from the existing bidirectional motion information and may add the derived motion information to the GPM merge list.

As shown in FIG. 9, in the conventional geometric motion prediction method, the video decoding apparatus may use the merge candidate in the GPM merge list directly as motion information for motion prediction of the first block partition and the second block partition.

Meanwhile, the video decoding apparatus may derive motion information related to GPM in a manner similar to that described above even in the AMVP mode of inter prediction.

The following describes a method of efficiently transmitting additional information over the above-described geometric partition information, i.e., information related to partitioning boundaries.

The following embodiments are described with a focus on the video decoding apparatus, but they can be implemented in the same or similar manner in the video encoding apparatus.

### III. Embodiments According to the Present Disclosure

At least one embodiment performs prediction of geometric partitioning mode information for efficiently transmitting additional information related to geometric partitioning, and transmits a difference for complementing the prediction. Here, the additional information includes high level information related to geometric partitioning mode and difference information of geometric partitioning mode.

The video decoding apparatus decodes the high level information from the bitstream to derive information on whether the geometric partitioning is to be applied to the target video for decoding. In addition, the high level information may include one or more of the following information items: information indicating the number of blocks divided according to the geometric partitioning mode, the minimum size of the blocks divided according to the geometric partitioning mode, the minimum horizontal size or minimum width, the minimum vertical size or minimum height, and mask information applicable for blending processing in the geometric partitioning mode. Here, the size may be the number of pixels.

The video decoding apparatus decodes block-level geometric partitioning mode information for block-level decoding. The video decoding apparatus determines whether the geometric partitioning mode is to be applied on a block-by-block basis. This may use a flag indicating whether the geometric partitioning mode is to be applied on a block-by-block basis. When the current block is partitioned according to the geometric partitioning mode, the video decoding apparatus derives the partitioning boundary information of the current block based on the number of partitions or the number of partitioned blocks presented in the high level information.

The video decoding apparatus checks whether there are neighboring blocks reconstructed in geometric partitioning mode. The video decoding apparatus checks, at the block boundaries between the neighboring blocks reconstructed in geometric partitioning mode and current block, whether there are contact points corresponding to the partitioning boundaries of the neighboring blocks. If such a contact point exists, the video decoding apparatus uses the corresponding contact point and the partitioning boundary information of the neighboring block to predict the partitioning boundary information of the current block. Hereinafter, the predicted partitioning boundary information of the current block is referred to as the partitioned boundary predictor. For example, the partitioned boundary predictor may include a distance and an angle as shown in Table 1.

The video decoding apparatus uses the parsed difference information of the geometric partitioning mode in relation to the partitioned boundary predictor to derive the partitioning boundary information of the current block according to the geometric partitioning mode. For example, the video decoding apparatus may sum the partitioned boundary predictor and the parsed difference information to generate the partitioning boundary information of the current block.

The video decoding apparatus follows the geometric partitioning mode, e.g., uses the merge mode to perform block-wise prediction and thereby generate predicted signals of the current block. In addition, the video decoding apparatus may apply a mask filter for blending processing to the neighboring predicted signals of the partitioning boundary to generate final predicted signals of the current block.

As described above, the high level information may include at the high level whether block partitioning is to be applied, the number of partitioned blocks, the minimum area of the partitioned block, the minimum number of horizontal pixels, the minimum number of vertical pixels, mask filter information, and on the like. For example, high level information based on various combinations of the above information items may be signaled. The high level information may be transmitted at various levels, such as frames, slices, frame groups, slice groups, and video groups.

As an example, when transmitting the high level information related to geometric partitioning mode, the syntax in Table 2 may be applied.

TABLE 2

| | |
|---|---|
| GPM{ | |
| gpm_flag | ae(v) |
| If( gpm_flag){ | |
| num_gpm1 | ae(v) |
| gpm_size | ae(v) |
| } | |
| . . . | |
| } | |

In Table 2, the video decoding apparatus parses gpm_flag which is a flag indicating whether geometric partitioning mode is to be applied at the high level. If the parsed flag is true and geometric partitioning mode is applied, the video decoding apparatus parses the number of partitioned blocks and the partitioned blocks' minimum size (area). The video decoding apparatus uses num_gpm1 to obtain the number of partitioned blocks. For example, the number of partitioned blocks is calculated by adding 2 to num_gpm1. For example, if num_gpm1 is 0, the number of partitioned blocks is 2. In this case, partitioning is performed once according to the geometric partitioning mode. Additionally, when num_gpm1 is 1, partitioning is performed twice, resulting in 3 partitioned blocks according to the geometric partitioning mode. In this embodiment, the minimum area of the partitioned block cannot be smaller than the minimum size of the prediction block defined in the encoding and decoding methods with this embodiment applied. As an example, the video decoding apparatus may sum the minimum size of the prediction block and gpm_size to calculate the size of the partitioned block according to the geometric partitioning mode. At this time, the prediction block also includes subblocks partitioned from the current block.

In Table 2, ae(v) represents syntax elements that are context-adaptively and arithmetically encoded.

As an example, when transmitting the high level information related to the geometric partitioning mode, the syntax in Table 3 may be applied.

TABLE 3

| | |
|---|---|
| GPM{ | |
| num_gpm2 | ae(v) |
| If(num_gpm! = 0) | |
| gpm_size | ae(v) |
| . . . | |
| } | |

In Table 3, the video decoding apparatus parses num_gpm2 to check whether geometric partitioning mode is to be applied and the number of partitioned blocks. num_gpm2 indicates the number of partitions according to the application of geometric partitioning mode. For example, when num_gpm2 is 0, the current block is not divided according to geometric partitioning mode. In other words, the geometric partitioning mode is not applied to the current block. If num_gpm2 is 1, the current block is partitioned once, resulting in two partitioned blocks according to the geometric partitioning mode. Similarly, if num_gpm2 is 2, the current block is partitioned twice, resulting in three partitioned blocks according to the geometric partitioning mode. Therefore, the video decoding apparatus parses the partitioned block's minimum size (area) when num_gpm2 is not 0.

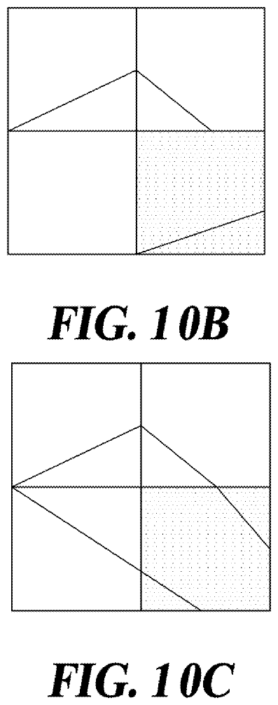

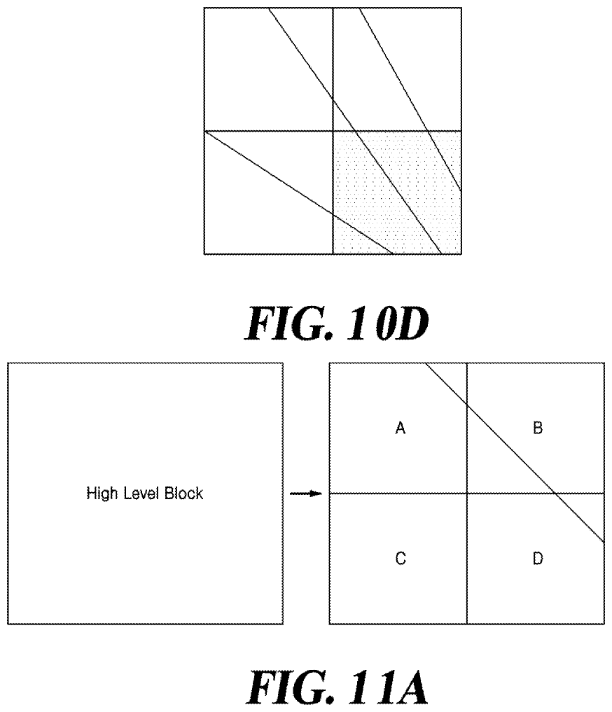

FIGS. 10A through 10D are diagrams illustrating the prediction of geometric partition information, according to some embodiments of the present disclosure.

This embodiment may use the partitioning information of blocks reconstructed before the current block to generate a partitioned boundary predictor of the current block. By utilizing such a generation of the partitioned boundary predictor, the video encoding apparatus can effectively transmit geometric partition information. In FIGS. 10A to 10D, the darkened blocks are the current block, and the blank blocks represent previously decoded blocks.

The video decoding apparatus according to this embodiment is responsive to the geometric partitioning mode being applied to the decoded neighboring blocks of the current block, for predicting the partitioning information of the current block by using the geometric partitioning mode information of the neighboring blocks. The illustration in FIG. 10A describes a case where geometric partitioning mode is applied to one or more of the decoded neighboring blocks, and there is a contact point between the partitioning boundary corresponding to the applied partitioning mode and the block boundary of the current block. The video decoding apparatus may use the aforementioned contact point as a basis for predicting the partitioning boundary of the current block. The video decoding apparatus generates a partitioned boundary predictor of the current block by determining that the predicted partitioning boundary of the current block is a straight line extended from the partitioning boundary of the previously decoded block. The video decoding apparatus adds difference information to the partitioned boundary predictor to generate the final partitioning boundary information of the current block. Here, the difference information is defined in a lookup table as shown in Table 4 according to an agreement between the video encoding apparatus and the video decoding apparatus. The difference information includes a combination of delta_distance (hereinafter referred to as distance differences) and delta_angle (hereinafter referred to as angle differences) which are added to the partitioned boundary predictor.

TABLE 4

| gpm_partition_idx | 0 | 1 | 2 | 3 | 4 | 5 | 6 | 7 |
|---|---|---|---|---|---|---|---|---|
| delta_distanceIdx | 0 | 0 | 0 | 0 | 0 | 0 | 0 | 0 |
| delta_angleIdx | 0 | 1 | 30 | 2 | 29 | 3 | 28 | 4 |
| gpm_partition_idx | 8 | 9 | 10 | 11 | 12 | 13 | 14 | . . . |
| delta_distanceIdx | 0 | 0 | 0 | 0 | 0 | 0 | 0 | . . . |
| delta_angleIdx | 27 | 5 | 25 | 6 | 27 | 7 | 26 | . . . |

The video encoding apparatus subtracts the partitioned boundary predictor from the partitioning boundary information of the current block to generate a distance difference and an angle difference. The video encoding apparatus uses the predefined lookup table shown in Table 4 to derive the index gpm_partition_idx which indicates the combination of a distance difference and an angle difference, and then signals the derived index to the video decoding apparatus. The video decoding apparatus decodes the above-described index and uses the index and Table 4 to derive the difference information, i.e., the combination of the distance difference and the angle difference. The video decoding apparatus uses the geometric partitioning mode information of neighboring blocks to generate a partitioned boundary predictor, then sums the derived difference information and the partitioned boundary predictor to generate the final partitioning boundary information of the current block. The video decoding apparatus confirms the partitioning boundary of the current block based on the final partitioning boundary information.

In the lookup table shown in Table 4, the number of angle differences mapped to delta_angleIdx is 31, which is not a necessary limitation. For example, the number of angle differences may be adaptively changed depending on the angle of the predicted partitioning boundary and the size/shape of the block to which GPM is applied. In Table 4, the angle difference is dependent on the index angleIdx which represents the angle shown in Table 1.

For example, the angular interval between two or more of delta_angleIdx, which is the interval between angle differences, may be a non-zero k-degree interval. For example, k may be an angle that evenly divides 180 degrees. In this case, the angular interval may be fixed according to an agreement between the video encoding apparatus and the video decoding apparatus. Alternatively, the k degrees or the number of divisions of 180 degrees by k degrees may be transmitted by using a high level syntax. In another example, k may not be a fixed value. In this case, the values mapped to delta_angleIdx may be transmitted to the lookup table. Alternatively, the values mapped to delta_angleIdx may be fixed according to an agreement between the video encoding apparatus and the video decoding apparatus.

In the lookup table shown in Table 4, the distance difference mapped to delta_distanceIdx is 0, but not necessarily limited thereto. Namely, the distance difference may vary depending on the position of the predicted partitioning boundary and the size of the block to which the geometric partitioning mode is applied. In Table 4, the distance difference is dependent on the distance index distanceIdx shown in Table 1.

Meanwhile, the number N of indices gpm_partition_idx indicating the combination of distance differences and angle differences, may be limited for coding efficiency optimization. The number N of indices may vary depending on the width, height, area, shape, or the like of the block to which the geometric partitioning mode is applied. In this case, the maximum value of N may be fixed according to an agreement between the video encoding apparatus and the video decoding apparatus. Alternatively, the maximum value of N may be transmitted by using a high level syntax.

Based on the number N of indices, when constructing the lookup table adaptively, the combination of a distance difference and an angle difference may be excluded as follows. For example, if the partitioning boundary refined based on the difference information indicated by gpm_partition_idx, is the same as the block boundary of the current block, the corresponding combination of delta_angleIdx and delta_distanceIdx is excluded from the lookup table configuration.

In the lookup table shown in Table 4, when gpm_partition_Idx is 0, the predicted partitioning boundary represents the same straight line as the partitioning boundary of the current block. When gpm_partition_Idx is 1, the current block is split at the same position as the boundaries' contact point, and the partitioning boundary's angle is the angle rotated clockwise by 1 angleIdx from the contact point. Additionally, when gpm_partition_Idx is 2, the current block is split at the same location as the boundary's contact point, and the partitioning boundary's angle is the angle rotated counterclockwise by 1 angleIdx from the contact point.

In this embodiment, the size of the partitioned block needs to satisfy the minimum size of the partitioned block. Therefore, a lookup table is constructed so that the partitioned block refined according to the combination of a distance difference and an angle difference, satisfies the minimum size. For example, after generating a partitioning boundary by adding the difference information indicated by gpm_partition_idx 0 to the partitioned boundary predictor, if any of the partitioned blocks does not satisfy the minimum size according to the generated partitioning boundary, the corresponding index may be excluded from the lookup table according to an agreement between the video encoding apparatus and the video decoding apparatus. At this point, the combination of the angle and the distance of index 1 may be changed to index 0. As mentioned above, the indices indicating the combinations of angle differences and distance differences within the lookup table may be determined adaptively.

On the other hand, if there are no neighboring blocks encoded in geometric partitioning mode, or if there is no contact point between the partitioning boundary of a block encoded in geometric partitioning mode and the block boundary of the current block, the generation of the partitioned boundary predictor is skipped. In this case, the video decoding apparatus may use only the information on the geometric partitioning mode received from the video encoding apparatus to generate the geometric partition information of the current block.

As another example for the effective transmission of geometric partition information, the present disclosure may use the continuity between the partitioning boundary of the current block and the partitioning boundary of a block to which GPM is applied among the previously decoded neighboring blocks. For example, a lookup table may be adaptively configured by using a combination of angleIdx and distanceIdx, which match or similarly generate contact points to the boundary between the neighboring block and the current block.

The video encoding apparatus may derive an index indicating the partitioning boundary of the current block from the adaptively configured lookup table and may transmit the derived index to the video decoding apparatus. A lookup table containing the number of cases for angles and distances that make up the existing merge_gpm_partition_Idx may be used, but the lookup table may be reconfigured excluding merge gpm_partition_Idx that does not split a block into a matching or similar position to the contact point at the boundary. Alternatively, the lookup table may be reconfigured by reordering the indices according to their proximity to the contact point. In this case, the lookup table may be adaptively configured so that the continuity related to the contact point at the boundary of the current block decreases as the value of merge_gpm_partition_Idx increases. This is because, due to the characteristics of videos, the probability of partitioning boundaries existing discontinuously, as illustrated in FIG. 10B, is smaller than the probability of them existing continuously, as illustrated in FIG. 10A.

In another example, as illustrated in FIG. 10C or FIG. 10D, when there are two or more partitioning boundaries extended to the current block, i.e., when there are two or more contact points, the video decoding apparatus may parse multiple gpm_partition_idx indices to generate difference information. Meanwhile, the number of partitioned blocks in the current block cannot exceed the number of geometrically partitioned blocks transmitted at the high level. If the number of partitioned blocks exceeds the number of geometrically partitioned blocks transmitted at the high level, the video decoding apparatus decodes the difference information corresponding to the higher priority in the decoding order, as illustrated in Table 5.

TABLE 5

| | |
|---|---|
| gpm_data( ) { | |
| For(i = 0; i < num_gpm1 + 1 or i < num_gpm2, i++) | |
| gpm_partition_idx[ i ] | ae(v) |
| . . . | |
| } | |

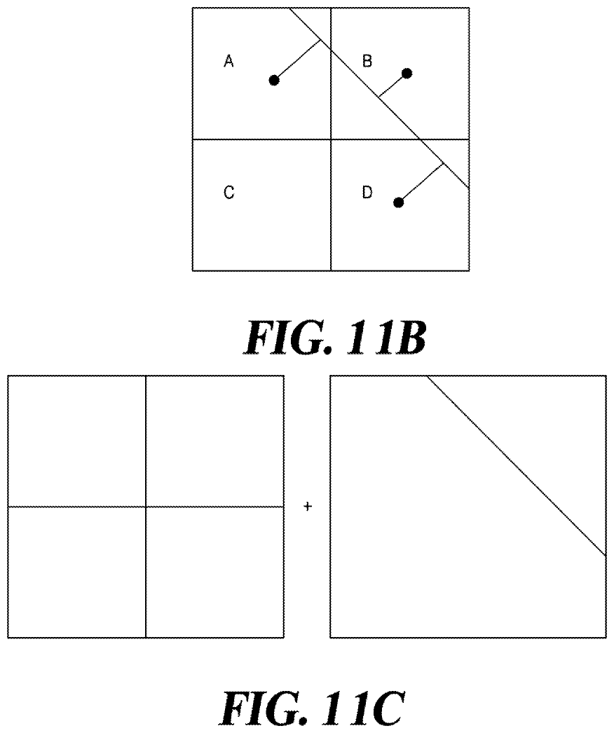

FIGS. 11A through 11C are diagrams illustrating a composite partitioning mode according to some embodiments of the present disclosure.

When transmitting geometric partition information as shown in FIG. 11B for such geometric partition as shown in FIG. 11A, quad-tree partition information may be transmitted for the high level block, and geometric partition information of each partitioned block may be transmitted. In the composite partitioning mode according to some embodiments of the present disclosure, for such geometric partition as the example in FIG. 11A, the high level block is partitioned in a composite form of two modes, namely, the conventional QT-based partitioning mode and the geometric partitioning mode, as illustrated in FIG. 11C. At this point, two partitioning modes may be transmitted as partitioning information at the high block level. For example, instead of partitioning the high level block according to the quadtree and then transmitting the geometric partitioning mode information of the partitioned block at each of A, B, C, and D, the present disclosure applies the quadtree partitioning and geometric partitioning at the same level, which can increase the transmission efficiency of the geometric partition information.

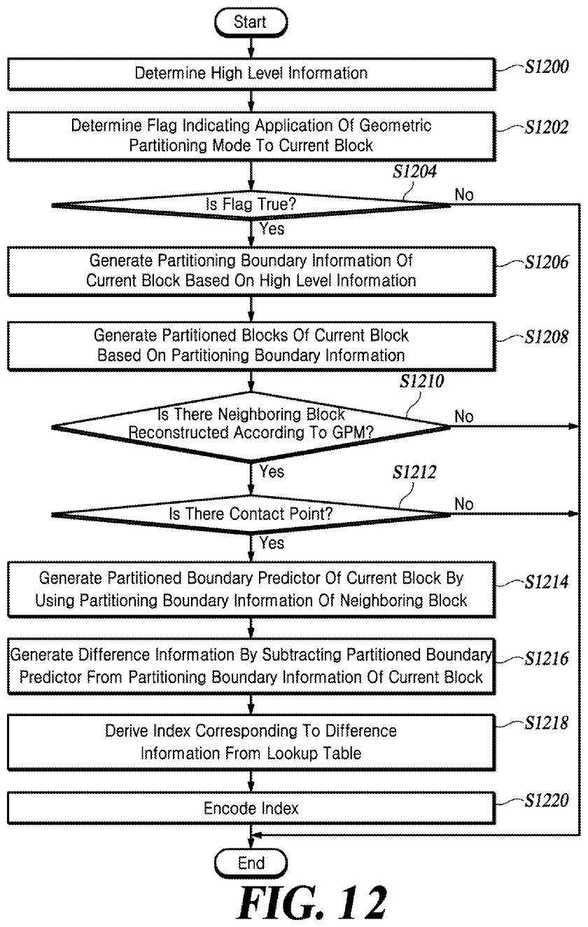

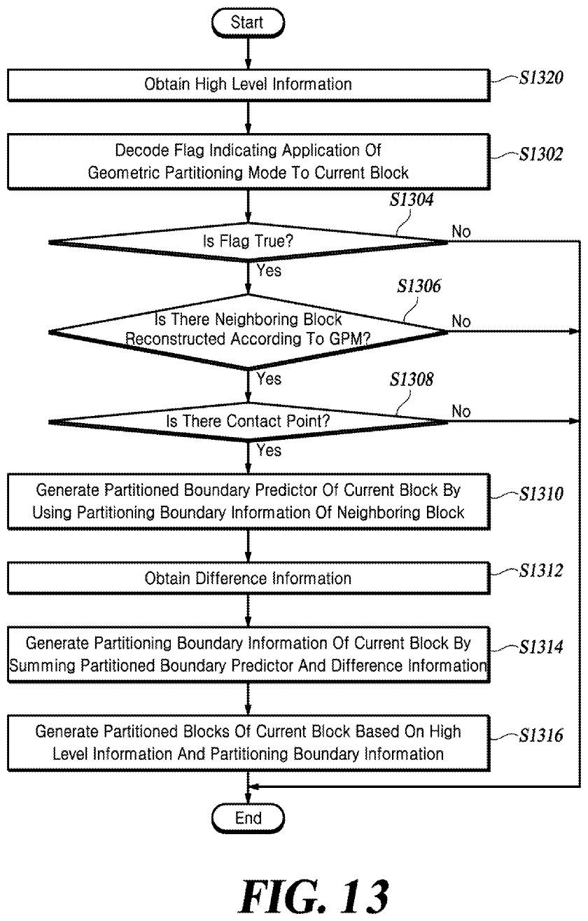

The following describes, by using the illustrations in FIGS. 12 and 13, methods of generating partitioned blocks of the current block according to the application of the geometric partitioning mode.

FIG. 12 is a flowchart of a method of encoding a current block by the video encoding apparatus, according to at least one embodiment of the present disclosure.

The video encoding apparatus determines high level information related to the application of the geometric partitioning mode (S1200).

Here, the high level information includes at the high level one or more of the following: information on whether the geometric partitioning mode is to be applied, the number of partitioned blocks according to the geometric partitioning mode, the minimum size of the partitioned block according to the geometric partitioning mode, and mask information applicable for blending processing. From the perspective of rate distortion optimization, the video encoding apparatus may determine the high level information.

The video encoding apparatus determines a flag indicating the application of geometric partitioning mode to the current block (S1202). From the perspective of rate distortion optimization, the video encoding apparatus may determine the flag indicating the application of geometric partitioning mode.

The video encoding apparatus checks the flag (S1204).

If the flag indicating the application of the geometric partitioning mode is false (No in S1204), the video encoding apparatus encodes the current block by using a method other than the geometric partitioning mode.

On the other hand, if the flag is true (Yes in S1204), the video encoding apparatus performs the following steps.

The video encoding apparatus generates partitioning boundary information of the current block based on the high level information (S1206). For example, the partitioning boundary information may include a distance and an angle as shown in Table 1.

The video encoding apparatus generates partitioned blocks of the current block based on the partitioning boundary information (S1208).

The video encoding apparatus checks whether there is a neighboring block reconstructed according to the GPM (S1210).

The video encoding apparatus checks at the block boundaries between the neighboring blocks and the current block whether there is a contact point according to the partitioning boundaries of the neighboring blocks (S1212).

If there is at least one contact point (Yes in S1210 and S1212), the video encoding apparatus performs the following steps.

The video encoding apparatus uses the partitioning boundary information of the neighboring blocks to generate a partitioned boundary predictor of the current block (S1214).

The video encoding apparatus subtracts the partitioned boundary predictor from the partitioning boundary information of the current block to generate difference information

(S1216). For example, the difference information includes a combination of a distance difference and an angle difference as shown in Table 4.

The video encoding apparatus derives an index corresponding to the difference information from a lookup table (S1218).

As an example, when one or more contact points exist, the video encoding apparatus derives an index corresponding to the difference information from a predefined lookup table.

As another example, when one or more contact points exist, the video encoding apparatus adaptively generates a lookup table based on the contact points and high level information. For example, if the partitioning boundary refined based on the difference information is the same as the block boundary of the current block, the video encoding apparatus configures the lookup table so that it does not include the above-mentioned index indicating the difference information. The video encoding apparatus configures the lookup table so that the partitioned block refined based on the combination of the distance difference and the angle difference satisfies the minimum size according to the application of the geometric partitioning mode. Alternatively, the video encoding apparatus constructs the lookup table by using combinations of distance differences and angle differences that match or similarly generate contact points.

The video encoding apparatus derives an index corresponding to the difference information from the constructed lookup table.

The video encoding apparatus encodes the index (S1220).

Meanwhile, if there are no neighboring blocks reconstructed in geometric partitioning mode (No in S1210) or if there are no contact points at all (No in S1212), the video encoding apparatus skips the generation of the partitioned boundary predictor and the generation of difference information.

FIG. 13 is a flowchart of a method of reconstructing a current block by the video decoding apparatus, according to at least one embodiment of the present disclosure.

The video decoding apparatus obtains high level information related to the application of the geometric partitioning mode (S1300).

Here, the high level information includes at the high level one or more of the following: information on whether geometric partitioning mode is to be applied, the number of partitioned blocks according to geometric partitioning mode, the minimum size of partitioned blocks according to geometric partitioning mode, or mask information applicable for blending processing.

The video decoding apparatus decodes from the bitstream a flag that indicates the application of geometric partitioning mode to the current block (S1302).

The video decoding apparatus checks the flag (S1304).

If the flag indicating the application of the geometric partitioning mode is false (No in S1304), the video decoding apparatus reconstructs the current block by using a method other than the geometric partitioning mode.

On the other hand, if the above-described flag is true (Yes in S1304), the video decoding apparatus performs the following steps.

The video decoding apparatus checks whether there is a neighboring block reconstructed according to the geometric partitioning mode (S1306).

The video decoding apparatus checks at the block boundaries between the neighboring blocks and the current block whether there are contact points according to the partitioning boundaries of the neighboring blocks (S1308).

If there is at least one contact point (Yes in S1306 and S1308), the video decoding apparatus performs the following steps.

The video decoding apparatus uses partitioning boundary information of the neighboring blocks to generate a partitioned boundary predictor of the current block (S1310).

The video decoding apparatus obtains the difference information of the geometric partitioning mode (S1312).

As an example, the video decoding apparatus decodes from a bitstream an index and uses the decoded index to derive difference information from a predefined lookup table.

As another example, the video decoding apparatus adaptively generates a lookup table based on the contact points and high level information. For example, the video decoding apparatus configures the lookup table so that it does not include the above-mentioned index indicating the difference information when a partitioning boundary refined based on the difference information is the same as the block boundary of the current block. The video decoding apparatus configures the lookup table so that the partitioned block refined based on the combination of the distance difference and the angle difference satisfies the minimum size according to the application of the geometric partitioning mode. Alternatively, the video decoding apparatus constructs the lookup table by using combinations of distance differences and angle differences that match or similarly generate contact points.

The video decoding apparatus uses the decoded index to derive the difference information from the constructed lookup table.

The video decoding apparatus sums the partitioned boundary predictor and the difference information to generate partitioning boundary information of the current block (S1314).

The video decoding apparatus generates partitioned blocks of the current block based on the high level information and the partitioning boundary information (S1316).

Meanwhile, if there is no neighboring block reconstructed in geometric partitioning mode (No in S1306) or if none of the above-described contact points exist (No in S1308), the video decoding apparatus skips the generation of the partitioned boundary predictor and the obtainment of difference information.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

124: inter predictor
155: entropy encoder
510: entropy decoder
544: inter predictor

### CROSS-REFERENCE TO RELATED APPLICATIONS

This application claims priority to and the benefit of Korean Patent Application No. 10-2023-0062811 filed on May 16, 2023, and Korean Patent Application No. 10-2024-0033416, filed on Mar. 8, 2024, the entire contents of each of which are incorporated herein by reference.

1. A method of reconstructing a current block by a video decoding apparatus, the method comprising:
obtaining high level information related to applying a geometric partitioning mode;
determining whether there is a neighboring block reconstructed according to the geometric partitioning mode; and
determining whether, at a block boundary between the neighboring block and the current block, there is a contact point due to a partitioning boundary of neighboring blocks,
wherein the method further comprises, when there is at least one or more of the contact point:
generating a partitioned boundary predictor of the current block by using partitioning boundary information of the neighboring block;
obtaining difference information of the geometric partitioning mode;
generating partitioning boundary information of the current block by summing the partitioned boundary predictor and the difference information; and
generating partitioned blocks of the current block based on the high level information and the partitioning boundary information.

2. The method of claim 1, further comprising:
decoding from the bitstream a flag indicating an application of the geometric partitioning mode to the current block; and
checking the flag,
wherein, when the flag is true, the method proceeds with determining whether there is the neighboring block reconstructed according to the geometric partitioning mode.

3. The method of claim 1, further comprising:
decoding the high level information from a bitstream,
wherein the high level information comprises at least one of:
whether the geometric partitioning mode is to be applied at a high level, a number of partitioned blocks according to the geometric partitioning mode, a minimum size of a partitioned block according to the geometric partitioning mode, or mask information applicable for blending processing.

4. The method of claim 3, wherein the geometric partitioning mode is not applied when the number of partitioned blocks is zero.

5. The method of claim 1, wherein the partitioning boundary information comprises:
a distance and an angle for applying the geometric partitioning mode.

6. The method of claim 1, wherein the difference information comprises:
a distance difference and an angle difference for adding to the partitioned boundary predictor.

7. The method of claim 1, wherein obtaining the difference information comprises:
decoding an index from a bitstream; and
deriving the difference information by using the index from a predefined lookup table.

8. The method of claim 7, wherein an interval between the angular differences in the predefined lookup table as the index increases is set to a preset angle.

9. The method of claim 1, wherein obtaining the difference information comprises:
decoding an index from a bitstream;
generating a lookup table based on the contact point and the high level information; and
deriving the difference information by using the index from the lookup table.

10. The method of claim 9, wherein generating the lookup table comprises:
configuring the lookup table not to include an index indicating the difference information when the partitioning boundary refined based on difference information is equal to a block boundary of the current block.

11. The method of claim 9, wherein generating the lookup table comprises:
configuring the lookup table such that a partitioned block, which is refined according to a combination of a distance difference and an angle difference, satisfies a minimum size according to applying the geometric partitioning mode.

12. The method of claim 9, wherein generating the lookup table comprises:
configuring the lookup table by using combinations of distance differences and angle differences that match or similarly generate contact points.

13. A method of encoding a current block by a video encoding apparatus, the method comprising:
determining high level information related to applying a geometric partitioning mode;
generating partitioning boundary information of the current block based on the high level information;
generating partitioned blocks of the current block based on the partitioning boundary information;
determining whether there is a neighboring block reconstructed according to the geometric partitioning mode; and
determining whether, at a block boundary between the neighboring block and the current block, there is a contact point due to a partitioning boundary of neighboring blocks,
wherein the method further comprises, when there is at least one or more of the contact point:
generating a partitioned boundary predictor of the current block by using partitioning boundary information of the neighboring block; and
generating difference information by subtracting the partitioned boundary predictor from the partitioning boundary information of the current block.

14. The method of claim 14, further comprising:
determining a flag indicating an application of the geometric partitioning mode to the current block; and
checking the flag,
wherein, when the flag is true, the method proceeds with generating the partitioning boundary information of the current block.

15. The method of claim 14, wherein the difference information comprises:
a distance difference and an angle difference for adding to the partitioned boundary predictor.

16. The method of claim 14, further comprising, when there is at least one or more of the contact point:
deriving an index corresponding to the difference information from a predefined lookup table; and
encoding the index.

17. The method of claim 14, further comprising, when there is at least one or more of the contact point:
generating a lookup table based on the contact point and the high level information;
deriving from the lookup table an index corresponding to the difference information; and
encoding the index.

18. A computer-readable recording medium storing a bitstream generated by a video encoding method, wherein the video encoding method comprises:
determining high level information related to applying a geometric partitioning mode;
generating partitioning boundary information of a current block based on the high level information;
generating partitioned blocks of the current block based on the partitioning boundary information;
determining whether there is a neighboring block reconstructed according to the geometric partitioning mode; and
determining whether, at a block boundary between the neighboring block and the current block, there is a contact point due to a partitioning boundary of neighboring blocks,
wherein the video encoding method further comprises, when there is at least one or more of the contact point:
generating a partitioned boundary predictor of the current block by using partitioning boundary information of the neighboring block; and
generating difference information by subtracting the partitioned boundary predictor from the partitioning boundary information of the current block.
